(19) United States
(12) Patent Application Publication
(10) Pub. No.: US 2012/0026669 A1
(43) Pub. Date: Feb. 2, 2012

(54) PORTABLE NETWORKING DEVICE

(75) Inventors: CHING-CHIANG FAN, CHIAYI CITY (TW); CHIN-CHANG CHIANG, NEW TAIPEI CITY (TW)

(73) Assignee: UNIVERSAL SCIENTIFIC INDUSTRIAL (SHANGHAI) CO., LTD., Shanghai (CN)

(21) Appl. No.: 12/984,750

(22) Filed: Jan. 5, 2011

(30) Foreign Application Priority Data
Jul. 28, 2010 (TW) 99214380

(51) Int. Cl. G06F 1/16

(52) U.S. Cl. 361/679.31; 361/679.55

(57) ABSTRACT

A portable networking device has a casing, a power connector, a power adapting unit, a circuit board, and a networking interface disposed on the circuit board. A receiving space is formed on an exterior side surface of the casing, and the power connector is fixed inside the casing. The power adapting unit is fixed inside the casing and electrically connected to the power connector, where the power connector can selectively connected to a detachable power plug or a power cord having a connector. The detachable power plug has a pair of conducting pins, which can be rotatably received inside the receiving space of the casing. The circuit board is disposed in the casing. The instant disclosure includes the detachable power plug having concealable conducting pins, and no external power adapter is needed. All of which allow for easy stowing and transport for the user.

### BACKGROUND OF THE INVENTION

1. Field of the Invention

The instant disclosure relates to a portable networking device; in particular, a device having a detachable power plug without external power adapter, is easy to carry, can be a storage device connecting individually to the network for storing, accessing, and data management, or can be a wireless networking device.

2. Description of the Related Art

Network Attached Storage (NAS) is developed as a more effective solution for data access over a computer network. As a data management device, the operating system and software of the NAS are specifically designed for file storage, file sharing, and other related purposes. The NAS acts as a data storage server between multiple computers and relieves the file serving responsibilities of a main server on a network. Thus, even in the event where the main servers are shut down or become unavailable for unforeseen reasons, data would remain accessible via the NAS. Also, by not relying on main servers and not competing for system/networking resources, the implementation of NAS allows faster data access over a network environment.

Component-wise, NAS usually has one or more hard disks arranged in an array known as RAID (Redundant Array of Independent Disks). The usage of multiple hard disks increases the storage capacity and availability for better data management. NAS has a broad scope of applications, ranging from personal and home office uses to enterprise-level applications.

Currently, there exists a supporting device called a NAS adapter for connecting a NAS unit onto the computer network. The NAS adaptor itself usually does not contain built-in storage device. Instead, having one or more USB ports, the NAS adapter is capable of connecting to any USB storage device and sharing the storage resources over a network. The separation of data storage functions from the main servers by the NAS devices/adaptors can make network storage more flexible and efficient than the traditional all-in-one server setup. Moreover, the development of portable NAS devices and adaptors may provide even more flexibility and adaptability for the data storage of a computer network.

However, external power adapters are often required to power the NAS or the NAS adapter, thus causing inconvenience in the stowing and transport of the NAS equipments.

To address the above issue, the inventor conducted research and applied engineering principles in proposing the following solution.

### SUMMARY OF THE INVENTION

The object of the instant disclosure is to provide a portable networking device, which has data storage capability or acts as an adapter for the storage device The device uses different power plugs for different settings. In particular, a detachable power plug is included to enhance portability.

The portable networking device comprises a casing, an internal power connector, a power adapting unit, an internal circuit board, and a network connector disposed on the circuit board. A receiving space is defined by a recessed side surface of the casing. The power adapting unit is fixed inside the casing and connected electrically to the power connector. The power connector can be attached to a detachable power plug, which has a rotatable member to hide or expose the pins. Alternatively, the power connector can be attached to a conventional power cord.

For advantages, the portable networking device has a compact design, a detachable power plug, and does not need an external power adapter. All of which enhance the portability of the networking device.

To further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is an exploded view of a portable networking device of the instant disclosure.

FIG. 2 is an exploded view of a detachable power plug for the portable networking device of the instant disclosure

FIG. 2A is an exploded view of a casing for the detachable power plug of the instant disclosure.

FIG. 3 is an isometric view of the portable networking device attached to a power cord of the instant disclosure.

FIG. 4 is an isometric view of the portable networking device with exposed pins of the instant disclosure

FIG. 5 is another isometric view of the portable networking device with exposed pins of the instant disclosure

FIG. 6 is an isometric view of the portable networking device with concealed pins of the instant disclosure.

### DETAILED DESCRIPTION OF THE PREFERRED EMBODIMENT

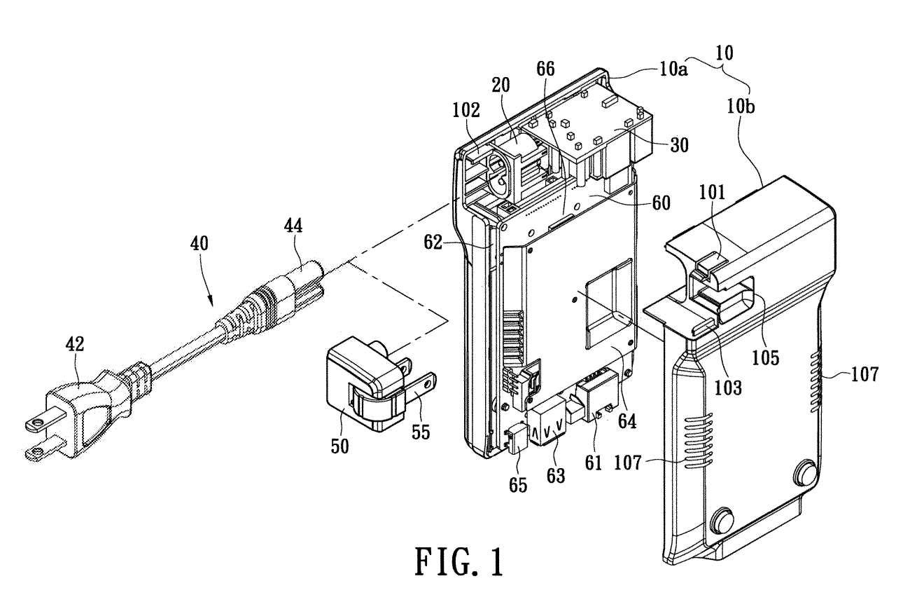

Please refer to FIG. 1, which shows an exploded view of a portable networking device of the instant disclosure. The device comprises a rectangular casing 10, a power connector 20, a power adapting unit 30, and a circuit board 60.

In the exemplary embodiment, the device further includes a data storage unit 62 disposed besides the circuit board 60. The data storage unit 62 is usually a hard disk for storing and sharing data files. Optionally, a wireless transmission module 66 can be disposed next to the circuit board 60 for engaging wireless communication. The bottom of the circuit board 60 has a network interface 61, such as a RJ45 female connector for computer networking, and at least one electrical interface 63. The electrical interface 63 can be a standard USB port or a mini USB port 65.

Noteworthy, the portable networking device of the instant disclosure can be a NAS by incorporating the data storage unit 62. Alternatively, by dismissing the data storage unit 62, the portable networking device becomes a NAS adapter instead. Through the network, the NAS adapter can allow multiple computers to access data files or be connected to an external hard disk, a flash drive, a printer, a webcam, or the like via the electrical interfaces 63 and 65. In addition, when the network cable is unavailable, the instant disclosure can use the wireless transmission module 66, to allow multiple computers to access data files or be connected to an external hard disk, a flash drive, a printer, a webcam, or the like via the electrical interfaces 63 and 65.

The structural composition of the portable networking device is as follows. The casing 10 is made up by a first casing member 10a and a second casing member 10b. A receiving space 105 is formed on the exterior side surface of the second casing member 10b. A plurality of venting grids 107 are formed on the casing 10 for heat dissipation.

The power connector 20 is partially exposed of the casing 10. For the instant disclosure, a detachable power plug 50 and a power cord 40 having a power plug 42 can be selectively attached to the power connector 20. The power adapting unit 30 is enclosed by the casing 10 and electrically connected to the power connector 20, thus providing power input to the circuit board 60.

For the instant disclosure, the portable networking device has a compact design, which allows for easy stowing and transport. As shown in FIG. 1, the device can stand upright, or be laid down flatly (not shown). In FIG. 1, the power adapting unit 30 is disposed behind the power connector 20, where both are located at the upper end within the casing 10. Relative to the circuit board 60, the power connector 20 and the power adapting unit 30 are located near the upper edge thereof. Meanwhile, a heat sink 64 is disposed on one side of the circuit board 60. For the portable networking device, the maximum thickness is determined by the dimensional aspect of the detachable power plug 50. The thicknesses of all other portions are thinner than the detachable power plug 50. The overall thickness of the device is approximately twice the width of a 110 VAC power plug, and the venting grids 107 are disposed across the thickness of the casing 10 for heat dissipation.

Based on the surroundings, the portable networking device can either attach to a power cord 40 having a power plug 42 or a detachable power plug 50. The option allows the device to have more flexibility in receiving electricity input. Meanwhile, the internal power adapting unit 30 converts the voltage from the line power for the device. The detachable power plug 50 includes a rotatable member 57 with a pair of conducting pins 55, which can be received in the receiving space 105 of the casing 10 to hide therein. Therefore, no external power adapter is necessary, which enables the user to stow and transport the device more easily.

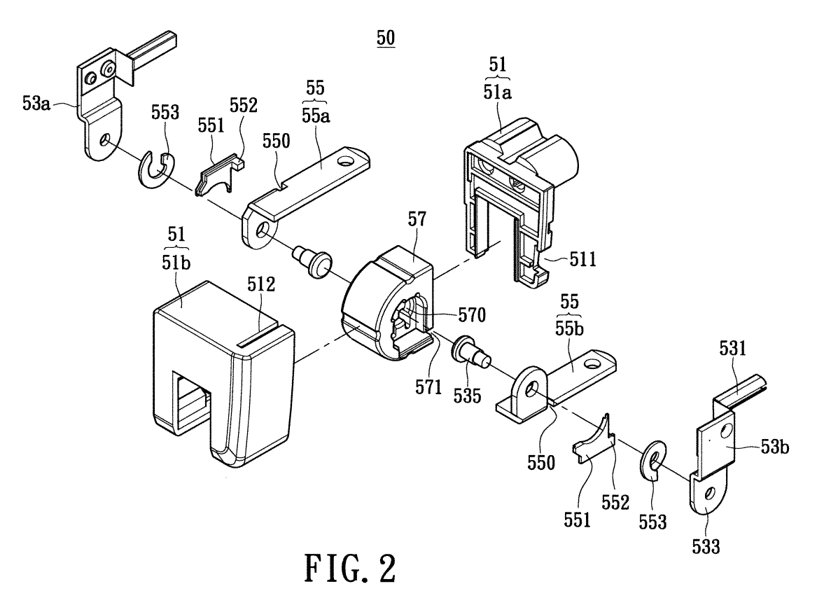

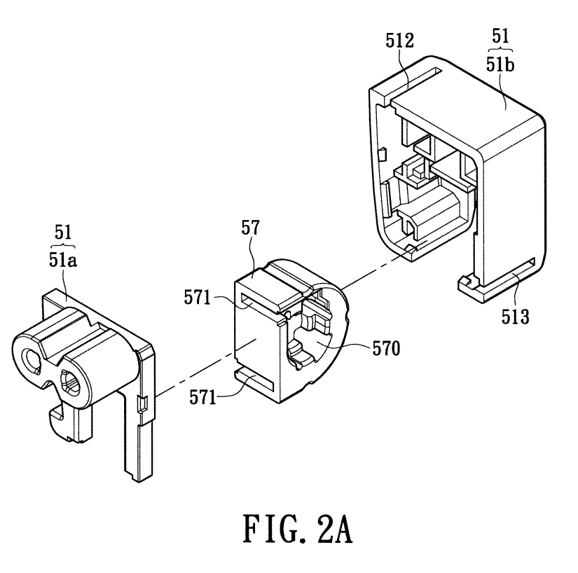

With reference to FIG. 2, which shows an exploded view of the detachable power plug 50, and a detailed explanation is given here. The detachable power plug 50 includes an insulating body 51, a pair of connecting members 53a and 53b, a pair of conducting pins 55a and 55b, and a rotatable member 57 sandwiched by the connecting members 53a and 53b. The conducting pins 55a and 55b are partially received in the rotatable member 57. The insulating body 51 comprises a cover 51a and a U-shaped holder 51b.

The connecting members 53a and 53b are received inside the insulating body 51 for connecting to the power connector 20. Specifically, the connecting members 53a and 53b are L-shaped and each has a contacting end 531 for connecting to the power connector 20. Meanwhile, the connecting members 53a and 53b are interconnected to the conducting pins 55a and 55b via fixing ends 533.

In the exemplary embodiment, a pair of rivets 535 is used to interconnect the conducting pins 55a and 55b to the connecting members 53a and 53b at the fixing ends 533. The rivets 535 run through the conducting pins 55a and 55b and the fixing ends 533. A pair of receiving slots 570 is formed on the rotatable member 57 to receive the head portions of the rivets 535. To secure the conducting pins 55a and 55b to the rotatable member 57, a pair of locking pieces 551 is used. Specifically, each locking piece 551 has a protrusion 552 for engaging to the matching groove 550 on the conducting pins 55a and 55b. A pair of slots 571 is formed on the rotatable member 57 to receive the locking pieces 551. Thus, the conductng pins 55a and 55b are secured to the rotatable member 57. In addition, interconnected by the rivets 535, a pair of flexible members 553 is disposed in between the conducting pins 55a and 55b and the connecting members 53a and 53b respectively. The locking pieces 551 and the flexible members 553 are made of metallic materials.

The rotatable member 57 can be rotatably received inside the insulating body 51. The rotational axis of the rotatable member 57 is parallel to the long axle of the casing 10. The conducting pins 55a and 55b can be selectively rotated and be perpendicular to the adjacent side surface of the casing 10.

For mounting the detachable power plug 50 to the casing 10, a structural description is given here with reference to FIGS. 1 to 2A. As for the casing 10, an engaging member 101 is formed on the upper surface of the second casing member 10b. Correspondingly, an engaging slot 511 is formed on the cover 51a of the insulating body 51 for the detachable power plug 50. In the exemplary embodiment, the engaging member 101 is disposed on the upper surface of the second casing member 10b, and the engaging slot 511 is formed on the cover 51a. At least one set slot 512 is formed on the insulating body 51 of the detachable power plug 50. At least one set piece 102 is formed on the casing 10 in corresponding to the set slot 512. Please refer to FIG. 2A, where in the exemplary embodiment, two set slots 512 and 513 are formed on the holder 51b in a diagonal orientation. Two set pieces 102 and 103 are formed on the casing 10. The set pieces 102 and 103 guide and secure the detachable power plug 50.

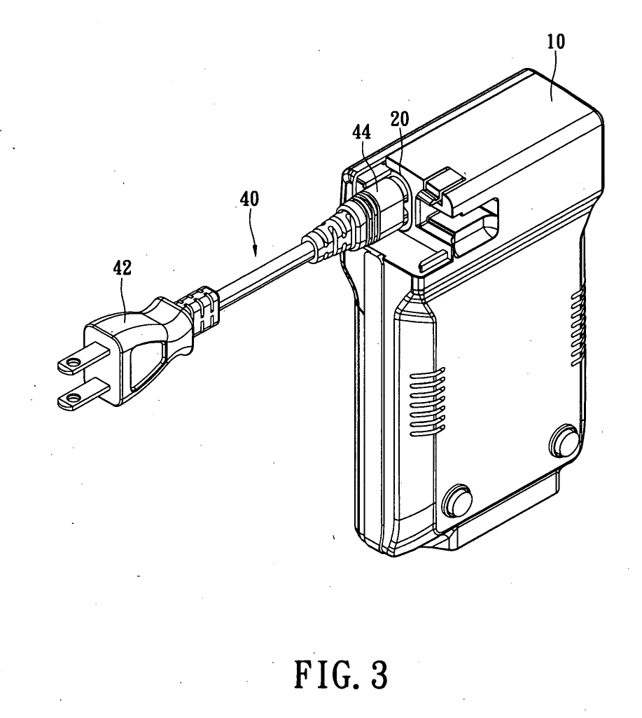

Please refer to FIG. 3, which shows an isometric view of the portable networking device attached to the power cord 40. The connector 44 of the power cord 40 is plugged to the power connector 20, and the power plug 42 is connected to the line power.

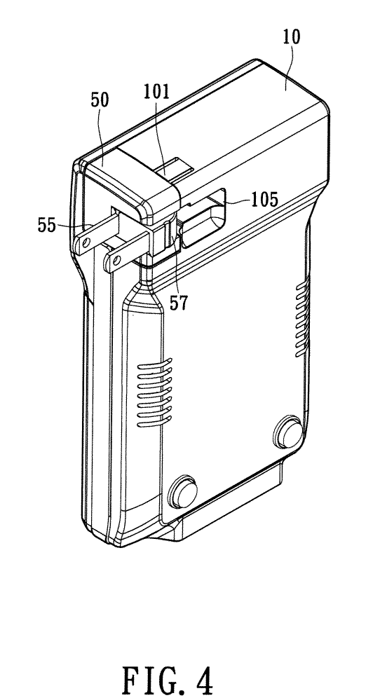

Alternatively, the portable networking device can be attached to the detachable power plug 50 as shown in FIG. 4, where the rotatable member 57 is rotated to expose the conducting pins 55. The conducting pins 55 can be selectively rotated to be perpendicular to the adjacent side surface of the casing 10. Relative to the flat surface of the receiving space 105 of the casing 10, the conducting pins 55 rotate in a parallel fashion. In other words, the exposed conducting pins 55 are perpendicular to the side surface of the casing 10.

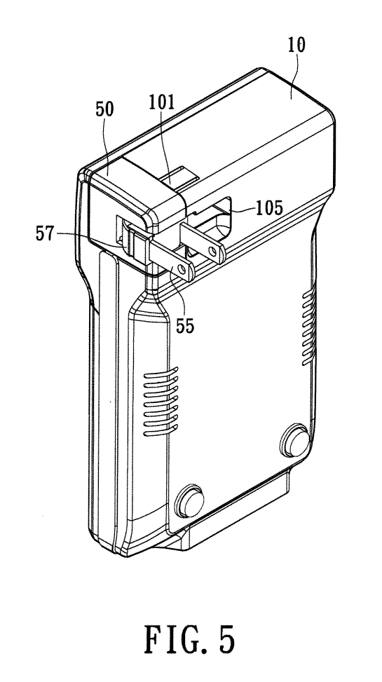

Likewise, FIG. 5 shows another isometric view of the portable networking device attached to the detachable power plug 50, where the conducting pins 55 are exposed at another orientation. In the figure, the conducting pins 55 of the detachable power plug 50 are rotated and perpendicular to the bottom face of the casing 10.

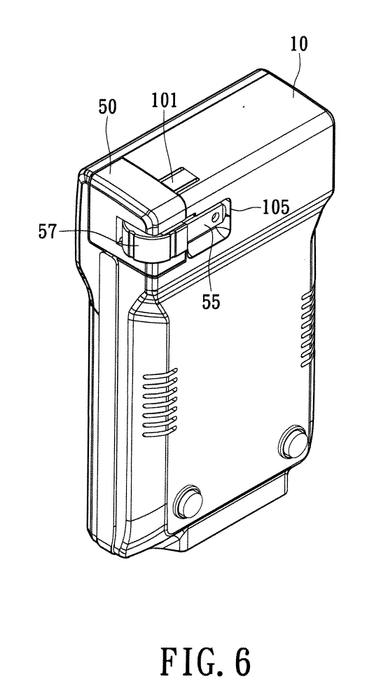

For FIG. 6, the conducting pins 55 of the detachable power plug 50 are received in the receiving space 105 of the casing 10, which makes easy for stowing and transport. By pressing the engaging member 101 on the casing 10, the detachable power plug 50 can be released off to dismount from the casing 10.

For advantages, the portable networking device of the instant disclosure has a compact design. Also, the detachable power plug has concealable conducting pins. In use, the conducting pins can be exposed at two orientations, and no external power adapter is needed. All of which allow for easy stowing and transport for the user.

The descriptions illustrated supra set forth simply the preferred embodiments of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A portable networking device, comprising:
a casing having a receiving space concavely formed on a side wall
thereof;
a power connector disposed inside the casing;
a power adapting unit disposed inside the casing and connected electrically to the power connector, wherein the power connector can selectively connect to a detachable power plug or a power cord having a connector, and wherein the detachable power plug has a pair of rotatable conducting pins;
a circuit board disposed inside the casing; and
a network connector disposed on the circuit board.

2. The portable networking device of claim 1, wherein the detachable power plug comprises an insulating body, a pair of connecting members received inside the insulating body and inserted to the power connector, wherein the pair of conducting pins are rotatably abutting to the connecting members, and a rotatable member rotatably disposed in between the connecting members and partially accommodating the conducting pins, wherein the pair of conducting pins is rotatably received inside the receiving space of the casing.

3. The portable networking device of claim 2, wherein the top surface of the casing has a press-able engaging member for connecting a matching engaging slot on the insulating body of the detachable power plug.

4. The portable networking device of claim 3, wherein at least one set slot is formed on the insulating body of the detachable power plug for connecting mechanically to a matching set piece on the casing.

5. The portable networking device of claim 2, wherein the rotational axis of the rotatable member is parallel to the long axle of the casing, and wherein the exposed conducting pins are perpendicular to the side walls of the casing.

6. The portable networking device of claim 2, wherein the connecting members are L-shaped, and wherein each connecting member has a contacting end for connecting to the power connector and a fixing end interconnected to the corresponding conducting pin.

7. The portable networking device of claim 6, further comprising a pair of rivets for interconnecting the connecting ends and the conducting pins, wherein the rotatable member has a pair of receiving slots to receive the head portions of the rivets.

8. The portable networking device of claim 7, further comprising a pair of locking pieces disposed inside the receiving slots and over the outer surface of the conducting pins, wherein the locking pieces secure the conducting pins to the rotatable member.

9. The portable networking device of claim 1, wherein the power adapting unit is located behind the power connector, and wherein the power adapting unit and the power connector are disposed within the top portion of the casing.

10. The portable networking device of claim 1, wherein the power adapting unit and the power connector are disposed near the edge of the circuit board.

11. The portable networking device of claim 1, further comprising a data storage unit disposed on one side of the circuit board.

12. The portable networking device of claim 1, further comprising an electrical interface disposed on the circuit board.

13. The portable networking device of claim 1, further comprising a wireless transmission module disposed on one side of the circuit board for wireless communication.
